(19) United States
(12) Patent Application Publication
(10) Pub. No.: US 2012/0225396 A1
(43) Pub. Date: Sep. 6, 2012

(54) HEATER ASSEMBLY

(75) Inventors: Jürgen Harr, Motzingen (DE); Gottfried Klein, Althengstett (DE); Thomas Hartmann, Filderstadt-Bernhausen (DE)

(73) Assignee: Seuffer gmbH & Co. KG, Calw (DE)

(21) Appl. No.: 13/496,839

(22) PCT Filed: Sep. 16, 2010
(86) PCT No.: PCT/EP10/05707

§ 371 Date: May 15, 2012

(30) Foreign Application Priority Data
Sep. 17, 2009 (DE) 10 2009 041 938.1

(51) Int. Cl. F27D 1/00

(52) U.S. Cl. 432/120

(57) ABSTRACT

A heater assembly for a tank 1 for storing a fluid reducing agent 2 for reducing harmful components in the exhaust gas of internal combustion engines, said heater assembly comprising a primary enclosure 5 which can be deployed in a lower portion of the tank 1 and which has an outlet opening 12 in a predetermined region 11 of the primary enclosure; and a heating device 18 for heating the reducing agent 2, said heating device 18 being disposed in the predetermined region 11 of the primary enclosure 5.

The present invention relates to a heater assembly for a tank used for storing a fluid reducing agent for reducing the amount of harmful components in the exhaust gas from internal combustion engines.

Due to the combustion of fuel in internal combustion engines, the exhaust gases resulting from combustion contain environmentally harmful substances that necessitate at least partial purification of the exhaust gases. In vehicles driven with diesel fuel, specifically, it is necessary that the proportion of nitrogen oxides (NOx), in particular, be substantially reduced as a consequence of increasingly tough statutory regulations regarding the composition of exhaust gases.

In this connection, a method is known in which gaseous ammonia (NH₃) is introduced as a reducing agent into the exhaust flow in order to reduce the nitrogen oxide content in the exhaust gas and which selectively reacts with the nitrogen oxides in the exhaust gas to form nitrogen and water. When the method is applied in the field of internal combustion engines for vehicles, an aqueous urea solution carried in the vehicle is introduced via a dosing valve into the exhaust pipe and thus into the exhaust gas stream in order to produce ammonia. In that process, ammonia is formed from the aqueous urea solution, and the nitrogen oxides in the exhaust gas are converted by an appropriate catalytic converter.

The aqueous urea solution is stored in a separate tank, in the same way as the fuel.

For all-year operation of a vehicle with exhaust gas purification using the aqueous urea solution, it is important to realise that the aqueous urea solution flocculates or freezes at about −11° C. The separate tank used for the aqueous urea solution therefore needs a heating unit in order to keep at least some of the urea solution in the bank in a liquid state, or to liquify it at lower temperatures, so that it can be injected into the exhaust stream.

A system for maintaining the temperature of a urea water solution is known from DE 10 2007 055 032 A1, in which heating elements are disposed on a fluid line between the tank used for the urea water solution and an exhaust system of a motor vehicle, the heat output from the heating elements being controlled or regulated according to predetermined parameters. The heating element may be a PTC element (positor, PTC: Positive Temperature Coefficient). The heat output is controlled, more specifically, according to a measured temperature. The measured temperature may be the temperature of the urea water solution and/or an external ambient temperature.

In addition, DE 10 2006 027 487 A1 discloses a vehicle tank used for a liquid reducing agent, in particular for a urea solution, the tank having a plurality of chambers, and an integrated electrical heater in combination with a suction line for extracting the liquid urea solution being provided in one of the chambers in the form of an inner container. The inner container is disposed approximately in the middle of the tank, so that this region of the urea solution is heated first.

DE 10 2007 050 272 A1 discloses a tank for storing a reducing agent, the reducing agent in the form of an aqueous urea solution being heated by means of a heating device at predetermined places in the tank, in which an additional inner container is provided. The urea solution is extracted by means of a suitable suction line and in combination with an associated return pipe. The return pipe is thermally coupled to the heating device in order to exert a positive effect on the thawing of the frozen aqueous urea solution at low temperatures.

However, such arrangements of heating devices in a tank used for storing aqueous urea solution lead to complex arrangements of heating device and extraction pipe, with the result that a urea solution that is frozen at low ambient temperatures does not always thaw reliably, and that operation of the cold-started internal combustion engine free of disruptions is not always assured.

The object of the present invention is therefore to design a heater assembly, of the kind initially specified, for a tank used for storing a fluid reducing agent (such as an aqueous urea solution), in such a way that heating of the fluid reducing agent is improved with simplified measures, thus ensuring that reliable operation of the internal combustion engine in combination with suitable exhaust gas purification is achieved more quickly.

According to the invention, this object is achieved by a heater assembly for a tank used for storing a fluid reducing agent, in accordance with the features specified in claim 1, and by a tank for storing the fluid reducing agent and in which the heater assembly is used, in accordance with the features specified in claim 12.

According to a first aspect of the present invention, the heater assembly for a tank used for storing a fluid reducing agent for reducing harmful components in the exhaust gas of internal combustion engines comprises a primary enclosure which can be deployed in a lower portion of the tank and which has an outlet opening in a predetermined region of the primary enclosure, and a heating device for heating the reducing agent, said heating device being disposed in the predetermined region of the primary enclosure.

Disposing the heating device for heating up the reducing agent in the primary enclosure of the heater assembly, in a region of the primary enclosure in which the outlet opening is likewise disposed, ensures that, immediately after starting the vehicle, at least a small amount of aqueous urea solution is quickly formed around the heating device near the outlet opening, with the result that the aqueous urea solution can quickly be injected into the exhaust system of the internal combustion engine, thus permitting operation with desired exhaust gas purification, even at very low ambient temperatures and after the vehicle has been switched off for a long time with concomitant freezing of the entire aqueous urea solution. The heating device is disposed in the predetermined region of the primary enclosure and, in particular, can heat up the immediate surroundings around the outlet opening. In the further course of operation, the wider surroundings around the outlet opening and ultimately the total amount of the fluid reducing agent can then be warmed up and thawed accordingly.

According to another aspect of the present invention, the heater assembly is disposed in a tank used for storing the fluid reducing agent, such that the entire fluid reducing agent in the tank can be warmed up and thawed by means of the heating device of the heater assembly after a predetermined period of operation, for reliable operation of the internal combustion engine with gas purification.

Other embodiments of the invention are specified in the dependent claims.

The heating device disposed in the predetermined region of the heater assembly can surround the outlet opening at least partially. The heating device may be inserted in recesses disposed in the predetermined region of the primary enclosure, and the recesses may be adapted to an external shape of the heating device.

The heating device may have a main body and at least two rod members extending from the main body. The main body may also include a part-ring structure, and the rod members may extend in a substantially radial direction relative to and away from the part-ring structure.

The heating device of the heater assembly may comprise at least two separate parts, and these parts may be disposed in separate recesses in the predetermined region of the primary enclosure.

The recesses in the predetermined region of the primary enclosure may be arranged in the side that is on the outside after insertion of the primary enclosure into the tank, and matching projecting ribs may be formed on the inner side (in the direction of the tank interior).

A thickness of side walls of the recesses and the projecting ribs may have at least two values.

The primary enclosure may have an at least partially cylindrical housing section on the side that is on the inside after insertion within the tank, wherein said housing section has a cylindrical wall, and flow openings may be formed in the cylindrical wall.

More specifically, the heating device of the heater assembly can be inserted gaplessly into the recesses. The heating device may also be cast into the recesses of the primary enclosure. This ensures good heat transfer to the reducing agent. Casting the heating device also simplifies production.

According to another aspect of the present invention, a tank used for storing a fluid reducing agent for reducing harmful components in the exhaust gas of internal combustion engines includes a heater assembly according to the above specifications. The heater assembly can be deployed, specifically, in a bottom surface of the tank.

The invention shall now be described in greater detail with reference to preferred embodiments and to the following Figures, in which:

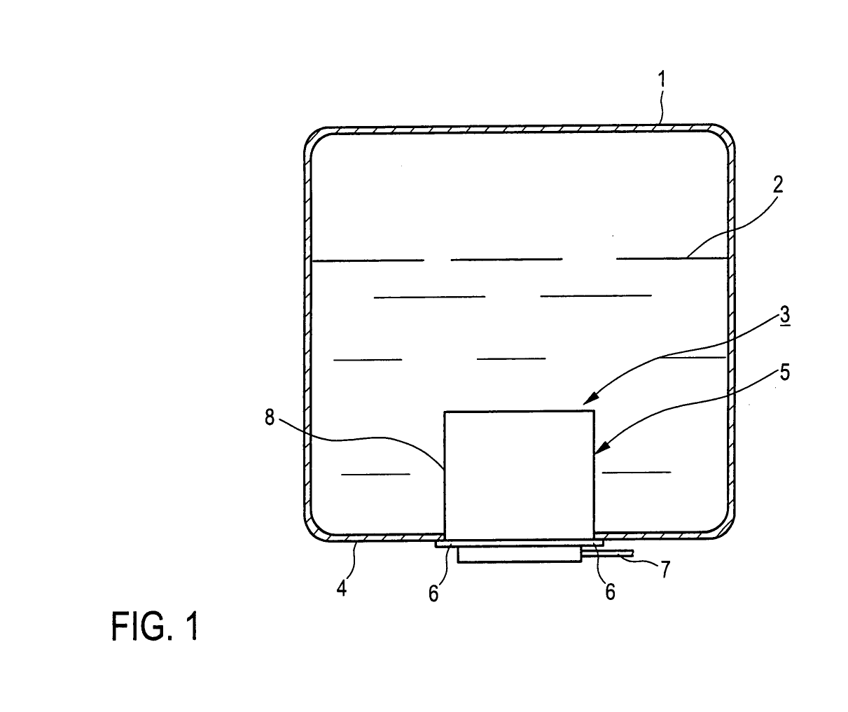

FIG. 1 shows an overall view in the form of a partial section of a tank used for storing a fluid reducing agent, in which the heater assembly according to any embodiment of the present invention is deployed,

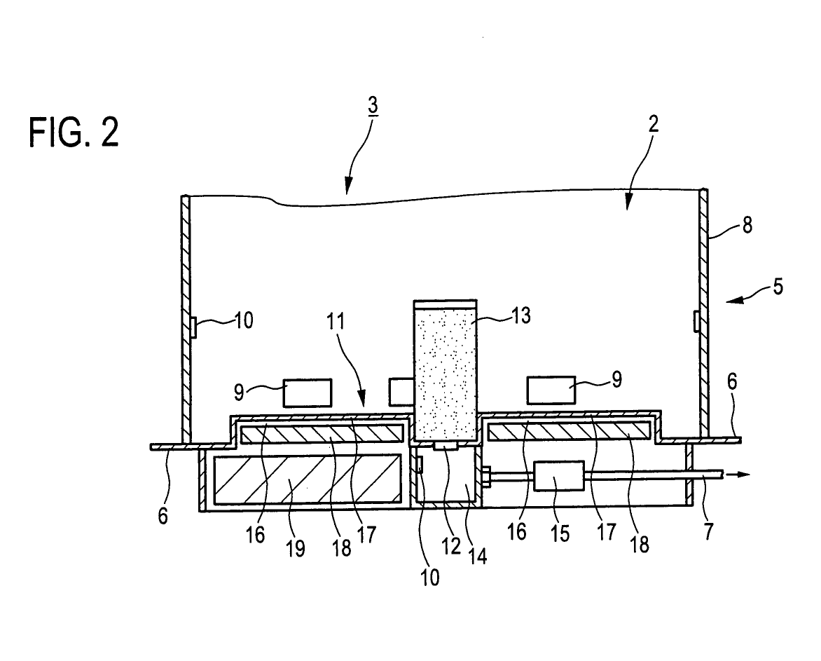

FIG. 2 shows a cross-sectional view of the heater assembly according to the embodiment of the present invention,

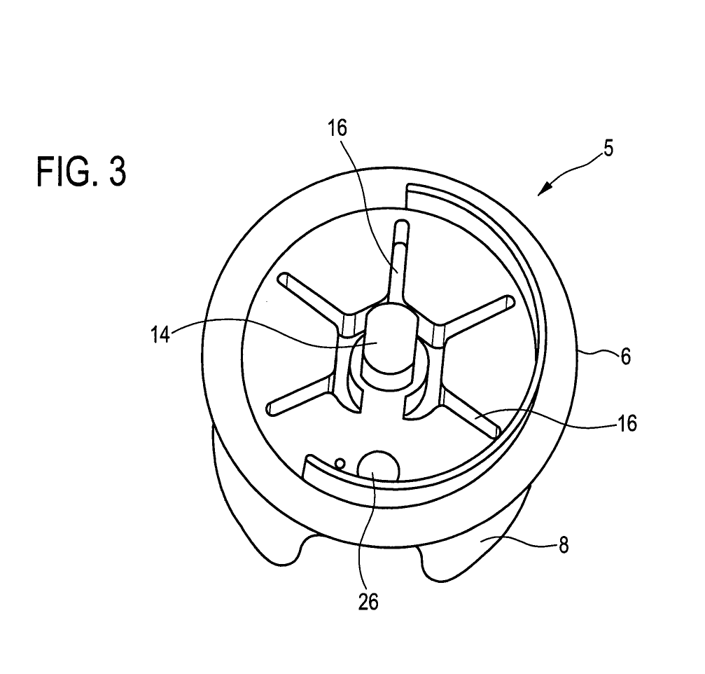

FIG. 3 shows a perspective view of a primary enclosure of the heater assembly according to FIG. 2, viewed from below,

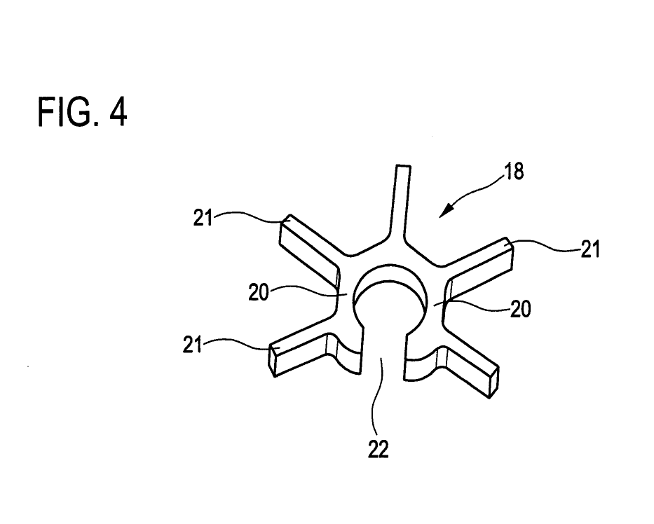

FIG. 4 shows a perspective view of the heating device to be inserted into the primary enclosure of the heater assembly,

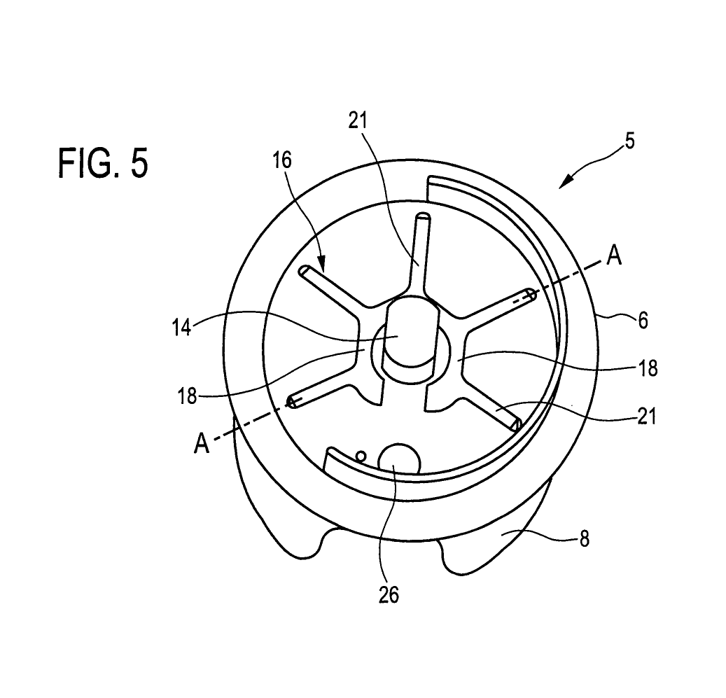

FIG. 5 shows a perspective view of the primary enclosure of the heater assembly according to FIG. 3, in which the heating device according to FIG. 4 has been inserted,

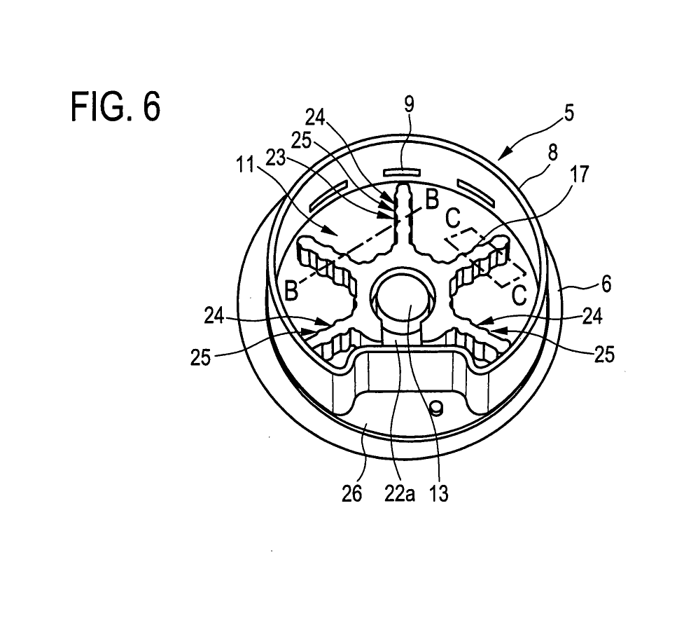

FIG. 6 shows a perspective view of the heater assembly according to FIG. 2, viewed from above,

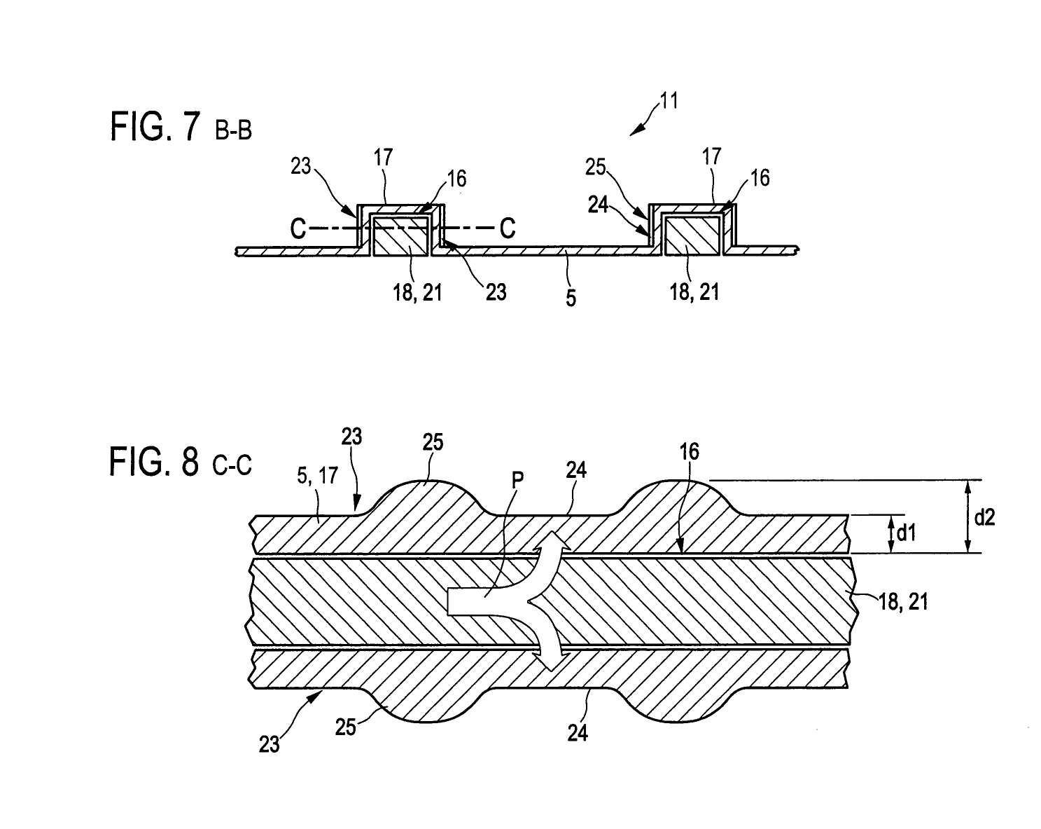

FIG. 7 shows a cross-section along the line B-B in FIG. 6, and

FIG. 8 shows a horizontal cross-section (along the line C-C in FIG. 6) through one of the ribs of the heater assembly in FIG. 6.

### DESCRIPTION OF PREFERRED EMBODIMENTS

FIG. 1 shows, in partial section, a tank 1, as may be disposed, for example, in a motor vehicle or in some other device, in which exhaust gas is to be purified using a fluid reducing agent 2, in combination with the operation of an internal combustion engine, and in particular of a diesel-driven internal combustion engine. In the present case, the reducing agent 2 is preferably an aqueous urea solution which is injected into the exhaust system of the internal combustion engine, in accordance with the above description in combination with the prior art, and in which the exhaust gases are converted in respective predetermined chemical reactions, thus achieving desired exhaust gas purification. Tank 1 is wholly or at least partially filled with the fluid reducing agent 2, for example with the aqueous urea solution. A heater assembly 3 is disposed in tank 1, and in particular is deployed at a predetermined position, preferably in a bottom base member of tank 1.

Heater assembly 3 includes a multipart or preferably integral primary enclosure 5 which has a flange 6 in a bottom region of the primary enclosure 5, by means of which flange the primary enclosure 5 of heater assembly 3 can be inserted into a respective opening in tank 1. Primary enclosure 5 is mounted in the opening (which is disposed, for example, in the base member of the tank) and is sufficiently sealed in respect of the fluid reducing agent 2.

Heater assembly 3 can also be connected to an extraction pipe 7. By means of extraction pipe 7 (which may also be provided in the form of a tube), an amount of the fluid reducing agent 2 sufficient to purify the exhaust gas may be removed and introduced via valve assemblies and injection units (not shown) into the exhaust system of the internal combustion engine (not shown).

In the view shown in FIG. 1, the heater assembly 3 that can be deployed in tank 1 is inserted substantially symmetrically in relation to the shape and dimensions of tank 1. However, the present invention is not confined thereto, and tank 1 may have any design and shape, in addition to a square design, wherein heater assembly 3 may also be inserted asymmetrically into tank 1 in relation to the shape and design of the latter, the only requirement being that heater assembly 3 is preferably located at the lowest point of tank 1 after insertion into tank 1 of whatever shape. In order to illustrate the entire assembly of tank 1 and heater assembly 3 insertable into tank 1, an exemplary view with substantially symmetrical ratios has been chosen.

In the view shown in FIG. 2, other details of heater assembly 3 according to the present invention are specified. More specifically, FIG. 2 shows a cross-sectional view of heater assembly 3, of the kind that can be deployed in tank 1.

Heater assembly 3 includes primary enclosure 5, which is located in an upper region as shown in the view in FIG. 2, i.e. in a region that is above the base member of tank 1, and a cylindrical wall 8 which projects upwards by a predetermined amount from the plane formed by flange 6 in FIGS. 1 and 2. Cylindrical wall 8 thus forms a cylindrical housing section of primary enclosure 5 that is open at the top and which is likewise filled with reducing agent 2, in the sense of communicating pipes, when tank 1 is filled with fluid reducing agent 2. Flow through the cylindrical housing section inside cylindrical wall 8 of primary enclosure 5 is ensured by flow openings 9.

A temperature sensor 10 is disposed at a place inside and preferably on cylindrical wall 8 In order to detect the temperature of reducing agent 2 inside cylindrical wall 8 (i.e. inside the substantially cylindrical housing section). Temperature sensor 10 may be disposed at any place inside cylindrical wall 8, and a plurality of temperature sensors whose respective detection signals are supplied to a central control unit (not shown) for analysis of the detected temperatures may be provided at other places. Additional temperature sensors may also be provided at predetermined places outside cylindrical wall 8, in particular at places inside tank 1, their respective detection signals being likewise supplied for analysis to the control unit (not shown).

Primary enclosure 5 of heater assembly 3 includes a predetermined region 11 inside cylindrical wall 8 and having the function of a base of the cylindrical housing section of primary enclosure 5. The predetermined region 11 of primary enclosure 5 may thus be disposed in the plane formed by flange 6 or in a plane above or below and adjacent (substantially parallel) thereto, as in the view shown in FIG. 2.

Preferably in the middle of predetermined region 11, an outlet opening 12 is provided by means of which the reducing agent 2 can be taken from the cylindrical housing section inside cylindrical wall 8 and thus from tank 1. Directly at outlet opening 12, a filter assembly 13 is disposed by means of which the reducing agent 2 flowing through outlet opening 12 when extracted is filtered for potential impurities, in order to prevent any obstructions in the direction of injection, for example when injecting the extracted reducing agent 2 into the exhaust system of the internal combustion engine.

An outlet chamber 14 that likewise communicates with outlet opening 12 is provided, through which the extracted reducing agent 2 flows and to which the extraction pipe 7 already shown in FIG. 1 can be connected. Extraction pipe 7 is preferably connected via a controllable valve mechanism 15 to heater assembly 3, and in particular to outlet chamber 14. The fluid reducing agent 2 to be extracted thus flows from tank 1 into the cylindrical housing section inside cylindrical wall 8 via filter assembly 13 and outlet opening 12 in the predetermined region 11 of primary enclosure 5 into outlet chamber 14, and from there via the controllable valve mechanism 15 by means of extraction pipe 7 for further treatment in the direction of the internal combustion engine, and in particular in the direction of the exhaust system associated therewith.

At predetermined locations, the predetermined region 11 of primary enclosure 5 (i.e. the base region of the cylindrical housing section inside cylindrical wall 8) has groove-like or slot-shaped recesses 16 which are formed from below in the predetermined region 11 in accordance with the view shown in FIG. 2, with the result that projecting ribs 17 are formed on the upper side of the predetermined region 11 in the special region having groove-shaped or slot-shaped recesses 16.

A heating device 18 filling almost the entire space inside recesses 16 and which may be disposed preferably gaplessly or with only a very small gap inside recesses 16 may be inserted into the groove-shaped or slot-shaped recesses 16, which lead on the top side of the predetermined region 11 according to FIG. 2 to the projecting ribs 17. Heating device 18 can be connected by electrical connecting lines not shown in FIG. 2 and be supplied with electric power for dispensing appropriate heat. The heat provided by means of heating device 18 is transferred via the wall thickness of recesses 16 and the projecting ribs 17 to the reducing agent 2 disposed in tank 1, so that the reducing agent can be heated up in this manner. In particular, the reducing agent 2 near ribs 17 is heated up first.

In FIG. 2, an electric connector unit is marked with reference numeral 19, the electric power being supplied to heating device 18 via connector unit 19, and detection signals from temperature sensors such as temperature sensor 10 on cylindrical wall 8 or from another temperature sensor 10 in outlet chamber 14 can be transmitted to the outside. Inside connector unit 19, any plug arrangement or connector arrangement may therefore be provided. Connector unit 19 may likewise have other electrical and/or electronic components and circuits that can serve as a control unit.

The further configuration of heating device 18 and its arrangement inside the primary enclosure 5 of heater assembly 3 is described in detail below with reference to FIGS. 3-6.

It has already been specified, with the view shown in FIG. 2, that heating device 18 is inserted into groove-shaped or slot-shaped recesses 16. FIG. 3 shows a view of heater assembly 3 in which, in contrast to the cross-sectional view in FIG. 2, primary enclosure 5 is viewed slantingly from below. Recesses 16 can be seen in primary enclosure 5 of heater assembly 3 and recesses 16 may have a straight or a curved shape and may also branch out. FIG. 3 shows, in a middle region inside the arrangement of recesses 16, the outlet chamber (outflow chamber) 14, which covers outlet opening 12 (FIG. 2) not shown in FIG. 3 and which can be connected to extraction pipe 7 either directly or via other fittings. Extraction pipe 7 and other fittings on the underside of primary enclosure 5, as shown in FIG. 2, have been omitted for better presentation of recesses 16.

FIG. 4 shows an embodiment of heating device 18, in which the depicted embodiment of heating device 18 has a ring-shaped structure or, as shown in the Figure, a part-ring structure 20. Part-ring structure 20 or a ring-shaped arrangement form a main body of heating device 18. A plurality of rod-shaped elements or rod members 21 are formed on part-ring structure 20. Rod members 21 may be produced as separate parts and attached to part-ring structure 20, or heating device 18 may be formed in its entirety as an integral unit.

Part-ring structure 20 has a recess 22, which according to the view shown in FIG. 3 is occupied by the part of primary enclosure 5 which is disposed therebetween. When heating device 18 shown in FIG. 4 is inserted into the matchingly embodied recesses 16 which follow the shape of heating device 18, an assembly such as the one shown in FIG. 5 is obtained. Heating device 18 is inserted almost gaplessly into recesses 16, such that heat produced in heating device 18 after activation with electric power can only be dissipated outwardly via the wall of the recesses (see FIG. 2) to the reducing agent 2 surrounding the projecting ribs 17. The heat produced in heating device 18 need only pass, therefore, through the walls of the groove-shaped or slot-shaped recesses 16 and the projecting ribs 17.

Recess 22 likewise engenders a cavity 22a of identical size and position in the predetermined region 11 of primary enclosure 5. Recess 22a is shown in FIG. 6, which will be described below.

Heating device 18 is thus held by positive engagement after insertion into recesses 16. Heating device 18 may be flush with the underside of predetermined region 11, or be disposed in a predetermined manner deeper inside recesses 16.

In the cross-section shown in FIG. 2, the individual components of heating device 18 in recesses 16 are indicated. The cross-sectional view in FIG. 2 thus shows, according to FIG. 5, a cross-section approximately along a line A-A, so the respective recesses 16 (or ribs 17) and the components of heating device 18, in particular rod members 21 according to FIG. 2, are shown as cross-sections in their respective longitudinal extension.

In comparison with the view shown in FIG. 5, FIG. 6 likewise shows a perspective view, but of the opposite side of the predetermined region 11 of primary enclosure 5. The view is therefore of primary enclosure 5 as seen at an angle from above it (i.e., in relation to FIG. 2, from the inside of tank 1).

Ribs 17 project upwards from a main plane of predetermined region 11, with heating device 18 (not visible in FIG. 6) inserted into them from underneath. However, it can be seen from the view in FIG. 6 that the ribs substantially follow the outer shape of heating device 18 as shown in FIG. 4.

The arrangement of ribs 17, in combination with the part-ring structure 20 of heating device 18 and rod members 21 show that the heating device 18 disposed inside ribs 17 is immediately adjacent to the outlet opening 12 not shown in FIG. 6 and also immediately adjacent to the filter apparatus 13 disposed above outlet opening 12. Due to the part-ring structure 20 being adjacent to filter assembly 13, a small region around filter assembly 13 or outlet opening 12 is heated up immediately after the vehicle enters operation, and power is concomitantly supplied to heating device 18, in the event that reducing agent 2 is almost completely frozen because of low ambient temperatures. This ensures that at least a small amount of reducing agent 2 is very quickly present in liquid form, suitable for being fed into the exhaust system of the internal combustion engine. More specifically, part-ring structure 20 aids rapid heating of the immediate surrounding of filter apparatus 13 near outlet opening 12 or near filter apparatus 13.

Recess 22 already specified above engenders a cavity 22a of identical size and position in the predetermined region 11 of primary enclosure 5. Cavity 22a, shown in FIG. 6, in predetermined region 11 is therefore a region into which the fluid reducing agent 2 can flow. When the fluid reducing agent 2, after being thawed by heating device 18, turns to liquid in the region of outlet opening 12, the reducing agent 2 can then flow in a simple manner towards outlet opening 12.

The further surroundings around filter apparatus 13, and thus the further space inside cylindrical wall 8 is created by means of the other components of heating device 18, i.e. by the plurality of rod members 21.

Rod members 21, as shown in FIG. 4, have a predetermined length in their plane of extension that is defined in such a way that they extend in the radial direction from part-ring structure 20, but are spaced apart by a certain amount from cylindrical wall 8. Similarly, therefore, the recesses and ribs 17 do not extend as far as the cylindrical wall, as shown in FIG. 6, and a plane of flow is formed around ribs 17 in predetermined region 11, with the result that the fluid reducing agent 2, or the fluid reducing agent 2 liquified by means of heating device 18, can flow in a simple manner to outlet opening 12. In the vicinity of heating device 18, i.e. near heat-transmitting ribs 17, liquified reducing agent 2 can thus flow from any position inside predetermined region 11 towards outlet opening 12. This ensures that even small amounts of liquified reducing agent 2 can be taken from tank 1 and can be used for exhaust gas purification.

FIG. 7 shows another cross-sectional view along the line B-B shown in FIG. 6. In this partial section of predetermined region 11, ribs 17 are shown on the top surface that are associated with recesses 16 on the underside of predetermined region 11. The individual components of heating device 18 are disposed in recesses 16. Rod members 20 are shown here in a cross-sectional view at an angle to their longitudinal extension. Reducing agent 2 is located above predetermined region 11 and projecting ribs 17.

FIG. 8 shows another cross-section illustrating how heating device 18 and its components are arranged in recesses 16 or ribs 17. This cross-sectional view is a horizontal section through area C-C of FIG. 6 or along line C-C in FIG. 7, said line indicating a plane which is perpendicular to the image plane of FIG. 7. In this sectional plane parallel to predetermined region 11, as shown in FIG. 8, heating device 18 or a rod member 21 is shown that is disposed inside side walls 23 of ribs 17 or recess 16. Side walls 23 enclose the components of heating device 18 fixedly and almost gaplessly, thus forming an optimal transition for the heat provided in heating device 18. The transfer of heat is shown in FIG. 8 by arrows P. The heat provided in heating device 18 penetrates side walls 23 in order to be transferred to reducing agent 2, which is present within cylindrical wall 8 and which flows around ribs 17.

The side walls 23 of ribs 17 or recesses 16 may have a predetermined thickness or wall thickness.

As shown in FIG. 8 and as also indicated at the ribs in FIG. 6, different wall thicknesses may also be provided at particular places, in addition to the possibility of a uniform thickness of side walls 23 (uniform wall thickness).

If a region 24 with a thin wall thickness d1 is referred to as a region with normal wall thickness and thus as a normal region, then another region 25 having a greater wall thickness d2 is referred to as a thick region. Normal region 24 has the substantially uniform wall thickness d1, whereas thick region 25 has the thicker wall thickness d2. In contrast to the surface of side wall 23 that is exposed to reducing agent 2, the clear space inside recesses 16 is designed with side walls as planar faces, so that heating device 18 with its respective components can be inserted almost gaplessly, as desired, and so that a mechanical contact required for heat transfer is formed.

As a result of the different wall thicknesses d1<d2, heat is preferably transferred through the thinner wall and thus in normal region 24. Thick region 25 will cause somewhat less heat transfer. However, the mechanical stability of ribs 17 and recesses 16 is improved on the whole by thick region 25, and advantages are achieved with regard to filling a shape (a tool) during production of primary enclosure 5.

The different wall regions, such as normal region 24 and thick region 25, are shown accordingly in FIG. 6. Areas of different thickness in side wall 23 exist not only in the region where the rod members 21 of heating device 18 and the associated recesses 16 or ribs 17 are disposed, but also where the recesses 16 and ribs 17 of part-ring structure 20 are located. This is shown in FIG. 6.

Primary enclosure 5 may consist of a metallic material. It is preferable, however, that primary enclosure 5 consists of a non-metallic material, and in particular of a plastic material that is resistant to reducing agent 2 and which is preferably formed by plastic injection moulding. Thick regions 25 of side walls 23 having a thicker wall thickness d2 therefore provide for better mould filling in plastic injection moulding, whereas normal regions 24 having thinner wall thickness d1 ensure optimal transfer of the heat generated by heating device 18 to reducing agent 2.

As is shown in FIGS. 4-6, heating device 18 has a part-ring structure 20 and rod members 21, and heating device 18 may be integrally formed. Heating device 18 and the associated shape of recesses 16 and ribs 17 is adapted in such a way that outlet opening 12 or filter apparatus 13 is enclosed at least partially inside the predetermined region 11 of primary enclosure 5. This is substantially achieved by the part-ring structure 20. The rod members 21 are disposed in a star-shaped arrangement on part-ring structure 20 and extend in a radial direction from part-ring structure 20, when it is assumed that in a middle region inside part-ring structure 20, for example in FIG. 6, there is a centre that is positioned approximately in the middle of outlet opening 12 or in filter assembly 13 (which are not shown).

Whereas the reducing agent 2 in the immediate surroundings of outlet opening 12 or of filter assembly 13 are preferably heated up by means of part-ring structure 20, the reducing agent 2 in the further surroundings inside the cylindrical housing section of primary enclosure 5 defined by cylindrical wall 8 is heated up by means of the rod members 21 in ribs 17. This ensures that, if reducing agent 2 is frozen, at least a small part of the reducing agent 2 can be liquified very quickly, thus ensuring that the internal combustion engine, including an exhaust gas purification system, can operate from an early operating state onwards.

In FIG. 6, an additional region 26 on primary enclosure 5 is shown. This region 26 is recessed from cylindrical wall 8 and does not lie inside predetermined region 11 or inside cylindrical wall 8. The additional region 26 relates to the option for disposing a sensor unit for detecting the filling level or amount of reducing agent 2 in tank 1. The sensor unit may preferably be disposed in region 26 and be embodied in the form of an ultrasound sensor by means of which a filling height can be detected. In combination with the known dimensions of tank 1, it is therefore possible to determine the fill volume.

In FIG. 4, heating device 18 is shown with a part-ring structure 20 and a plurality of rod members 21.

In one alternative embodiment, heating device 18 may also be designed in the form of a closed ring, such that a ring structure without a recess 22 is formed instead of a part-ring structure 20. A predetermined quantity of rod members 21, embodied either integrally or as separate components, can be attached to the alternative ring structure embodiment, in the same way as shown in FIG. 4.

In this case, when a ring structure without any recess 22 is present, the region of outlet opening 12 or filter apparatus 13 is completely enclosed, wherein the transmission of heat by heating device 18 preferably heats a region near outlet opening 12 or filter apparatus 13 at an early stage, in the same manner as with heating device 18 in FIG. 4.

According to another variant, heating device 18 can also be embodied in multiple parts, and the individual parts can be separately controlled with regard to electric power supply, such that the individual parts of heating device 18 can be supplied selectively with electric power, depending on existing operating states and conditions, either individually, in groups or collectively. Depending on a detected external temperature (ambient temperature) or a temperature of reducing agent 2, for example, the heat output to be supplied to heating device 18 can be controlled precisely and in accordance with requirements.

Heating device 18 may, for example, have a plurality of part-ring structures arranged like concentric rings, thus allowing recess 22 and cavity 22a (FIG. 6) to be formed. The recesses 22 of the respective part-ring structures are oriented thereby in such a way that a common aligned recess is formed. This leads to the favourable flow path for the fluid reducing agent, as described above. In the case of a plurality of concentrically arranged part-ring structures, the outer part-ring may have rod members 21.

In combination with the multipart embodiment of heating device 18 and in particular with the embodiment of heating device 18 with two or more concentric part-ring structures or ring structures, the individual components of the entire heating device 18 can be controlled separately according to requirements, or jointly. More specifically, a ring structure or part-ring structure disposed in the immediate vicinity of filter assembly 13 and around outlet opening 12 can be activated first and supplied with electric power (and temporarily with increased electric power if need be), so that the region around outlet opening 12 or filter assembly 13 is preferably heated or thawed first.

In the above description, for example of the assembly shown in FIGS. 3-5, heating device 18 was inserted into the prepared recesses 16 in the predetermined region 11 of primary enclosure 5. Heating device 18 was accommodated almost gaplessly by recesses 16 for good heat transfer to reducing agent 2.

In one alternative assembly, heating device 18 may be cast into primary enclosure 5 in the same shape as specified in FIG. 4, and at the same place as shown in FIG. 6 in combination with ribs 17, while primary enclosure 5 is preferably produced in a plastic casting (injection moulding) process. In this case, deviating from FIG. 5, heating device 18 is no longer accessible, after completion of primary enclosure 5 (except for respective connecting lines that are not shown), due to heating device 18 being enclosed with the material of primary enclosure 5. Instead, the heating device is fully cast with the material of primary enclosure 5.

Casting the heating device 18 during production of primary enclosure 5 likewise ensures that heating device 18 is disposed almost gaplessly inside recess 16 in the predetermined region 11 of primary enclosure 5, thus ensuring good heat transfer. The disposing (positioning) of heating device 18 by means of casting during production of primary enclosure 5 is the same as that achieved by insertion into recesses 16. Production can be accelerated in this way, and heating device 18 is largely protected from external impacts (damage, contamination).

According to another alternative, the normal regions 24 with thinner walls, and the thick regions 25 with thicker walls, as shown in FIGS. 6 and 8, may be disposed at regular distances apart. However, the invention is not confined thereto, and the thick regions 25 or normal regions 24 may be present in different quantities, at different distances apart and with different longitudinal extensions along rod members 21 or the part-ring structure 20. There is also the option of selecting the wall thickness d2 of the thick region 25 differently at different places in the arrangement of the respective thick regions 25, provided that wall thickness d2 is greater than the wall thickness d1 of the normal region 24.

According to the view shown in FIG. 6, the regions with different wall thicknesses d1 and d2, i.e. normal regions 24 and thick regions 25, are defined in combination with side walls 23 of recess 16 or ribs 17. In the view shown in FIG. 6, the substantially horizontal faces of ribs 17 are planar and have a uniform wall thickness. In the same way as side walls 23, however, the upper surfaces of ribs 17 may also have normal regions and thick regions with different respective wall thicknesses.

With regard to the external shape of heating device 18, as shown by way of example in FIG. 4, different shapes and also different designs of rod members 21 may be provided. It is necessary in any case that the recesses 16 disposed in the predetermined region 11 of primary enclosure 5 (and ribs 17 as well, therefore) be matched in respect of their external shape to heating device 18, so that heating device 18 can be inserted approximately gaplessly as an integral or multipart component into recesses 16, in order to ensure optimal heat transfer via the respective side walls 23 to reducing agent 2.

Another option, finally, is to provide heating device 18 with an appropriate casing, separate from the arrangement of primary enclosure 5, so that heating device 18 is isolated (encapsulated) from reducing agent 2, and the heating device provided with such a casing can be disposed on predetermined region 11 of primary enclosure 5, wherein the same basic structure as in the embodiments described in the foregoing is required so that the region around outlet opening 12 or filter assembly 13 is wholly or at least partially enclosed, and the heating device is located near outlet opening 12 or filter assembly 13. In the latter case, appropriate electric supply lines to heating device 18 must be provided.

Heating device 18 may generally consist of a metal material, such as aluminium, and suitable heating coils comprising resistance wires may be embodied in heating device 18. Alternatively, PTC elements (positors) may also be deployed as heat emitting elements in the metal body of heating device 18.

The present invention has been described in the foregoing with reference to preferred embodiments and to the associated Figures.

However, for a skilled person engaged in this field, it is self-evident that the configuration of the present invention according to the Figures described above, and the reference signs used for the respective parts and components in the Figures and the description, and the details provided by way of example are not to be interpreted in a limiting sense.

The shapes and proportions in the individual Figures are also shown in schematic and simplified form in order that the invention be better understood. The invention is not limited to the views provided, therefore, nor, in particular, to the dimensions shown. Rather, all embodiments and variants which come under the enclosed claims are considered to belong to the invention.

1. A heater assembly for a tank used for storing a fluid reducing agent for reducing harmful components in the exhaust gas from internal combustion engines, comprising:
a primary enclosure (5) which can be deployed in a lower portion of the tank (1) and which has an outlet opening (12) in a predetermined region (11) of the primary enclosure; and
a heating device (18) for heating the fluid reducing agent (2), wherein
the heating device (18) is disposed in the predetermined region (11) of the primary enclosure (5).

2. The heater assembly according to claim 1, wherein the heating device (18) at least partially surrounds the outlet opening (12) in the predetermined region (11).

3. The heater assembly according to claim 1, wherein the heating device (18) is inserted into recesses (16) provided in the predetermined region of the primary enclosure (5), and the recesses are adapted to an exterior shape of the heating device.

4. The heater assembly according to claim 3, wherein the heating device (18) has a main body (20) and at least two rod members (21) extending from the main body.

5. The heater assembly according to claim 4, wherein the main body (20) has a part-ring structure and the rod members (21) extend in a substantially radial direction relative to the part-ring structure.

6. The heater assembly according to claim 4, wherein the heating device (18) has at least two separate parts and said at least two separate parts are disposed in separate recesses in the predetermined region (11) of the primary enclosure (5).

7. The heater assembly according to claim 3, wherein the recesses (16) in the predetermined region (11) of the primary enclosure (5) are arranged in a side that is outside after insertion of the primary enclosure into the tank (1), and matching projecting ribs (17) are formed inside.

8. The heater assembly according to claim 7, wherein the thickness of side walls (23) of the recesses (16) and of the projecting ribs (17) has at least two values (d1, d2).

9. The heater assembly according to claim 7, wherein the primary enclosure (5) has an at least partially cylindrical housing section on the side that is on the inside after insertion inside the tank (1), said housing section having a cylindrical wall (8), and wherein flow openings (9) are formed in the cylindrical wall.

10. The heater assembly according to claim 3, wherein the heating device (18) is inserted gaplessly into the recesses (16).

11. The heater assembly according to claim 3, wherein the heating device (18) is cast into the recesses (16) of the primary enclosure (5).

12. A tank used for storing a fluid reducing agent for reducing harmful components in exhaust gas of internal combustion engines, comprising:
a heater assembly according to claim 1.

13. The tank according to claim 12, wherein the heater assembly is inserted into a bottom surface of the tank (1).
